(19) United States
(12) Patent Application Publication
(10) Pub. No.: US 2021/0300739 A1
(43) Pub. Date: Sep. 30, 2021

(54) On Site Logistics Using Autonomous Lifting Systems In Organized Use Sites

(71) Applicant: Halliburton Energy Services, Inc., Houston, TX (US)

(72) Inventors: Jim Basuki Surjaatmadja, Duncan, OK (US); Frank Kresse, Duncan, OK (US); Timothy Holiman Hunter, Duncan, OK (US); Carlos Alfredo Vallejo Gordon, Humble, TX (US); Alexander Simon Chretien, Duncan, OK (US)

(73) Assignee: Halliburton Energy Services, Inc., Houston, TX (US)

(21) Appl. No.: 16/828,445

(22) Filed: Mar. 24, 2020

(51) Int. Cl. B66F 9/06; B66F 9/075

(52) U.S. Cl. CPC B66F 9/063; G05D 1/0246; B66F 9/0755

(57) ABSTRACT

Systems, methods, and apparatuses of the present disclosure generally relate to on-site logistics using autonomous delivery vehicles in organized use sites. A system for on-site logistics includes a plurality of containers that are organized by type, each container including an identification tag. The system also includes at least three signal beacons configured to at least emit or receive signals, and at least one autonomous material handling device configured to locate the containers, move the containers, and store delivery points of the containers, wherein the at least one autonomous material handling device is in communication with the at least three signal beacons.

### BACKGROUND

Large amounts of materials may be delivered to a site in containers. Typically, a motorized forklift may be operated on the site to pick up a container and deliver the container to an intended delivery point. The forklift may be operated manually by a person, and due to the repetitive nature of manual forklift operations, accidents caused by human error may occur, which in turn may cause injuries or damage to property.

### BRIEF DESCRIPTION OF THE DRAWINGS

These drawings illustrate certain aspects of some of the embodiments of the present disclosure and should not be used to limit or define the disclosure.

FIG. 1 illustrates containers for containing various materials in accordance with examples of the present disclosure;

FIG. 2 illustrates a material handling device for moving containers in accordance with examples of the present disclosure;

FIG. 3 illustrates a material handling device configured to move a center of gravity of a lifted load in accordance with examples of the present disclosure;

FIG. 4 illustrates a site in accordance with examples of the present disclosure; and

FIG. 5 illustrates a flow chart for preparing a site in accordance with examples of the present disclosure.

### DETAILED DESCRIPTION

The present disclosure generally relates to a utilization of autonomous vehicles to perform delivery operations at a site. Specifically, systems, methods, and apparatuses of the present disclosure may utilize at least one self-driven motorized material handling device that may safely and autonomously navigate across a site to deliver containers from an origin to a delivery point. The containers may contain a solid, a liquid, and/or a gas, for example. Non-limiting examples of the material handling device may include a forklift, telehandler, crane, pallet stacker, boom loader, container reach stacker, or other purpose-built machines configured to lift, move, and place containers.

The material handling device may utilize a positioning system to monitor movement of the material handling device as the material handling device operates on the site. Examples of the positioning system include a global positioning system (“GPS”) and a local positioning system (“LPS”). The material handling device may be configured to store (e.g., in memory) locations of origins and delivery points, as well as move autonomously throughout the site safely, accurately, and efficiently. In some examples, the material handling device may follow prescribed navigation paths. In other examples, the material handling device may implement its own path based on locations of objects, people, origin and delivery points.

The containers may be organized by type. For example, the containers with the same content or material may be placed in the same designated area. In some examples, the containers may be stacked in the designated area (e.g., double stacks, triple stacks; no limit on number of stacks).

Each container may include an identification tag such as an RFID (radio frequency identification) tag and/or a barcode such as a UPC (universal product code), for example. The identification tag may contain identification data (“ID data”) including a name of the material contained within the container and status of the container (e.g., empty of the material or full of the material; or ready for delivery or not ready for delivery). The ID data may be read or scanned by a reader and/or a camera of the material handling devices, and transmitted to a system controller, in some examples.

The system controller may preside over the site and communicate (e.g., via radio frequency or other suitable communication protocols) with the material handling devices and may instruct the material handling devices in regard to operations on the site. For example, the designated areas may change at any time due to instructions received at the material handling devices from the system controller. Alternatively, the designated areas may change if the material handling devices observe that the designated areas are at container capacity.

In some examples, the containers may be selected based upon their ID data, and subsequently transported to a designated area such as on top of a support structure above a blender. In certain examples, the support structure may be equipped with indicators such as lights to indicate where each container should be exactly placed by the material handling device. The cameras of the material handling devices may detect the indicators which may guide the material handling devices to deliver the container to a correct space, such as a particular shelf, for example. Empty containers may be detected by the system controller and may be subsequently picked up by the material handling devices and placed in a designated area such as a side of a road to be picked up by an empty truck (e.g., autonomous or manual), as necessary. The cameras of the material handling devices may also detect irregularities, such as objects or people that may be in a navigation path of each of the material handling devices. Vision of the material handling devices may be assisted with signal or signal beacons for triangulation of each material handling device to determine the position of each of the material handling devices in LPS applications, for example.

The material handling devices may be programmed to accelerate or decelerate rapidly yet gradually in order to maintain balance of the material handling devices and their loads (e.g., the containers), to reduce chances of the material handling devices to tip over. Additionally, each material handling device may include an onboard computer to calculate turning radiuses of the material handling device based on a weight of the load and/or radial moments based on the weight of the load in order to prevent tipping of the material handling devices. That is, each material handling device may include load sensors on wheels, on wheel shafts, and/or adjacent to the wheels to determine massive load reductions or weight shifting, thereby allowing the material handling devices to slow down or straighten from a turn within milliseconds, for example.

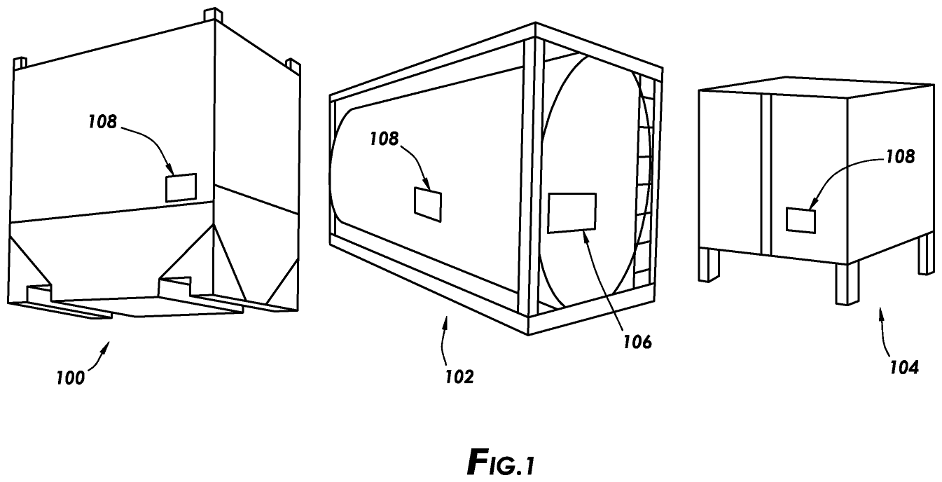

FIG. 1 illustrates exemplary containers 100, 102, and 104 that may be utilized to deliver material(s) in accordance with examples of the present disclosure. Weights of the containers and contents, volumes of the containers and the contents, transportability on highways and on site, connections to and from the containers, techniques to fill the containers, and logistics control systems may be factors considered when selecting a suitable container. The containers 100, 102, and 104 are non-limiting examples of different types of containers for varying industrial applications (e.g., a material handling device is needed to transport the containers).

In certain examples, the containers 100, 102, and/or 104 may have a volume ranging from 100 gallons through 1000 gallons (e.g., 350 gallons), for example. The weights of the containers 100, 102, and/or 104 may range from 500 pounds to 3 tons, such as 2 tons for example. In some examples, the weights of the containers 100, 102, and/or 104 may be less than 500 pounds. In other examples, the weights of the containers 100, 102, and/or 104 may be greater than 3 tons, such as from 3 tons to 10 tons, for example. Non-limiting examples of materials contained in the containers may include sand, proppants, cements, acids, CO₂, gases, liquids, plastics, chemical additives, or combinations thereof.

For example, the container 100 may be of a box-type shape, made of steel, and contain granular materials such as sand and/or proppant, for example. The container 102 may be of a cylindrical shape and may be insulated. The container 102 may be made of steel and contain a liquid such as water, brine, or a liquefied natural gas or a liquefied petroleum gas, for example. In other examples, the container 102 may contain a gas such as propane, carbon dioxide, nitrogen. Cryogenic fluids may also be contained within the container 102. In some examples, the container 102 may be coupled to a control system 106 for expanding a contained fluid slowly to maintain a low temperature (e.g., a low temperature for a cryogenic fluid) of the fluid.

The container 104 may be of a box-type shape, be made of steel, and contain material such as a liquid sand (a fluidized bed of sand), for example. Chemical additives may also be contained within the container 104. Non-limiting examples of chemical additives may pertain to the oilfield and may include chemicals stimulation chemicals such as gels, friction reducers, crosslinkers, gel breakers, buffers, clay controls, surfactants, scale inhibitors, or biocides, for example; or hydraulic fracturing fluid additives such as friction reducers, for example; or cementing additives such as set accelerators, set retarders, or dispersants, for example.

In certain examples, the containers 100, 102, and/or 104 may be utilized for water treatment applications. Water from a holding area (e.g., a tank or lake) may need treatment (e.g., ensure quality of the water based on pH) and may be pumped from the holding area into empty containers 100, 102, and/or 104 for transportation to a water treatment facility. Treated water may be pumped into clean containers 100, 102, and/or 104 and transported to various destinations. For example, the containers 100, 102, and 104 may be empty, or full of treated or untreated water. The containers 100, 102, and/or 104 may transported to a central hub, then redistributed to smaller hubs, and then delivered to a site that needs the containers 100, 102, and/or 104, in some examples.

The containers 100, 102, and/or 104 may include identification tags 108 (e.g., RFID tag and/or barcode). As noted earlier, the identification tags 108 may contain information (“the ID data”) that may include a name of the material contained within the container, and status of the container (e.g., empty of the material or full of the material; or ready for delivery or not ready for delivery), for example. The ID data may also include origin and delivery point information. In certain examples, the ID data may include a name of the material contained, a weight of the material, and/or a volume of the container, for example. The material handling devices may store the ID data locally on the onboard computers, for example.

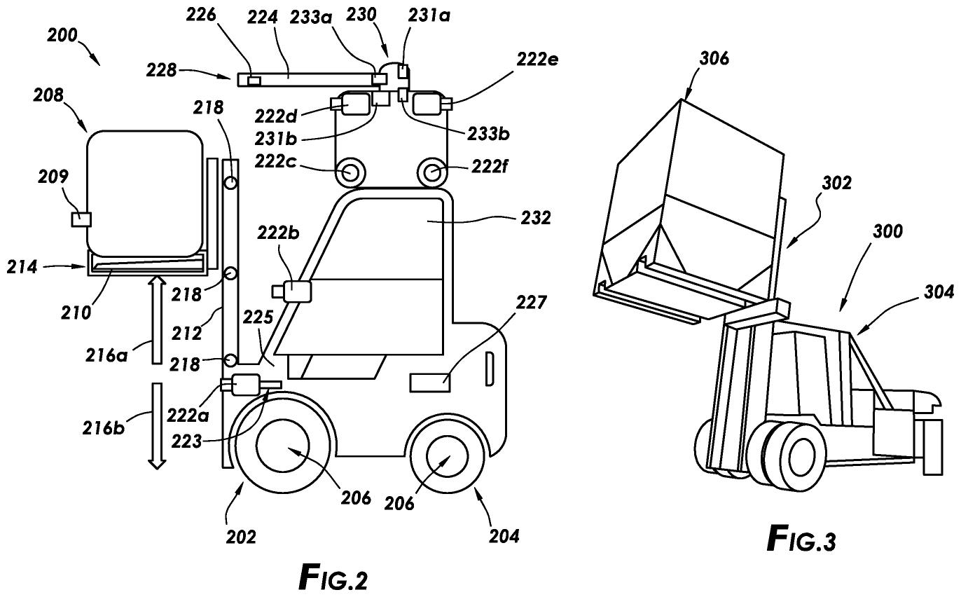

FIG. 2 illustrates a side view of an example of an autonomous material handling device 200 (“the material handling device 200”) in accordance with examples of the present disclosure. It should be noted that various components of the material handling device 200 are drawn for illustrative purposes and are not drawn to scale. The material handling device 200 may be a self-driven motorized device which may travel at speeds of up to 20 miles per hour, for example. As noted above, non-limiting examples of the material handling device may include a forklift, telehandler, crane, pallet stacker, boom loader, container reach stacker, or other purpose-built machines configured to lift, move, and place containers.

The material handling device 200 may transport the containers 100, 102, and/or 104 to desired locations. The material handling device 200 may include four wheels, however only two wheels are shown: wheels 202 and 204. The wheels 202 and 204 may be similar or different in size. For example, for increased stability and load tolerance, the wheels 202 may have a larger diameter than the wheels 204. The opposite side of the material handling device 200 may include wheels similar to the wheels 202 and 204, thereby forming pairs of the wheels 202 and 204, for example.

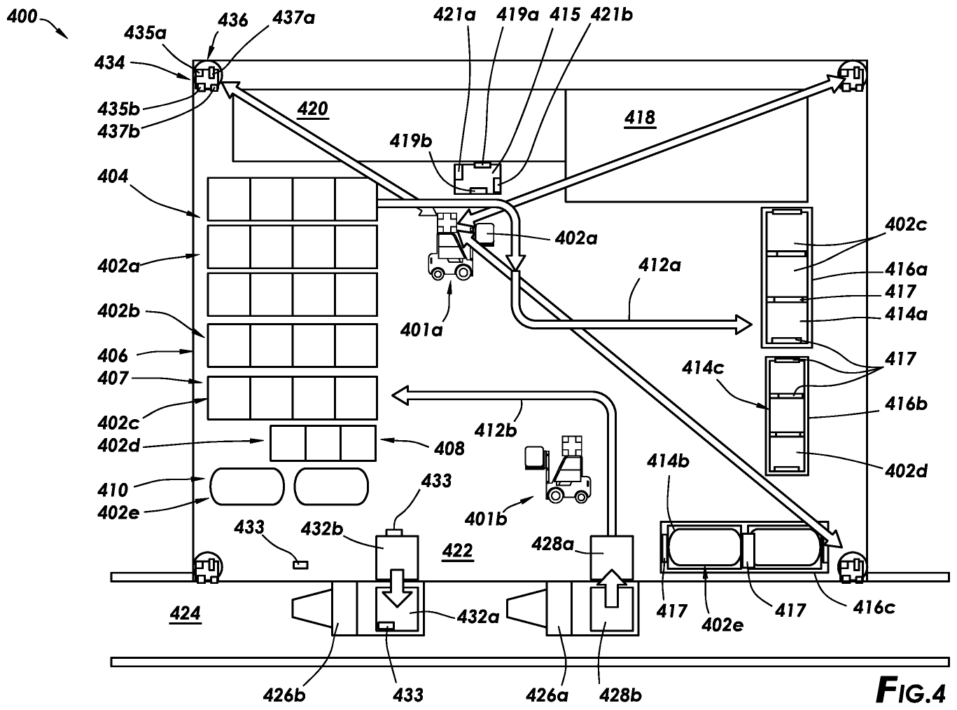

The wheels 202 and 204 may include wheel load sensors 206 configured to measure load (e.g., weight) exerted onto each of the wheels 202 and 204 due to a load 208 held by the material handling device 200. The load 208 may include any of the containers 100, 102, and 104. The wheel load sensors 206 may be force transducers or load cells positioned adjacent to each of the wheels 202 and 204, attached to each of the wheels 202 and 204, and/or attached to a wheel shaft that maybe attached to each of the wheels 202 and/or 204, for example. In some examples, the material handling device 200 may also include at least one fork 210 extending laterally from a rail 212 that may extend vertically. The fork 210 may extend through a bottom section 214 of the load 208. The bottom section 214 is depicted as transparent to allow viewing of the fork 210. The fork 210 may move vertically as indicated by arrows 216a (up) and 216b (down) along the rail 212. The fork 210 may be movably coupled to the rail 212 as should be understood by one having skill in the art with the benefit of this disclosure. The rail 212 may pivot or angle backward to improve stability, as shown on FIG. 3, for example. Load sensors may also be used to correct weight or present content of the containers.

The rail 212 may include load position sensors 218 disposed lengthwise along the rail 212. The load position sensors 218 may track movement and/or position (e.g., height) of the fork 210 and/or the load 208. Non-limiting examples of the load position sensors 218 may include a capacitive displacement sensor, Eddy-current sensor, hall effect sensor, inductive sensor, laser Doppler vibrometer, linear variable differential transformer, photodiode array, piezo-electric transducer; and position encoders such as an absolute encoder, incremental encoder, linear encoder, rotary encoder, potentiometer, proximity sensor, string potentiometer, an ultrasonic sensor; or combinations thereof. The material handling device 200 may also include cameras 222a-f. The cameras 222a-f may be positioned along a perimeter of the material handling device 200 to allow a 360° coverage area. For example, the cameras 222a-f may extend from the front (e.g., cameras 222a, 222b, and 222d), back (e.g., camera 222e), and lateral sides (e.g., cameras 222c and 222f) to allow 360° observation of a surrounding environment. The camera 222a may extend via a rod 223 that is coupled to a front portion 225 of the material handling device 200. This extension of the camera 222a may allow detection of the absolute position of a front end of the load 208. The cameras 222a-f may be utilized to read or scan barcodes of the identification tags (e.g., the identification tags 108 shown on FIG. 1 for example). The cameras 222a-f may allow detection of various features of the load 208 such as, for example, a connection spout 209. A range of detection for the cameras 222a-f may range from 0 feet to 100 feet, for example.

The cameras 222a-f may also allow the material handling device 200 to operate with the load 208 in a lowered position because there is no blockage of sight due to the cameras 222a-f that are positioned all around the material handling device 200. For example, in contrast to some examples of the present disclosure, a manually operated material handling device with a person as a material handling device operator, may need to keep the load in an elevated position to allow the material handling device operator to see in front of the material handling device. The material handling device 200 may also include a tube 224 that may be pivotable as well as retractable and extendable (e.g., telescopic) to facilitate reading of the identification tags 108 shown on FIG. 1, for example. The tube 224 may be made of metal and or plastic, for example. A reader 226 may be disposed within the tube 224 and reads the identification tags 108. The tube 224 is illustrated as transparent to allow viewing of the reader 226 that is disposed therein. The reader 226 may be configured to scan or read RFID tags and/or barcodes, for example.

In some examples, the reader 226 may be positioned within the tube 224 such that no portion of the reader 226 is closer than 1 inch from an opening 228 of the tube 224. Placement of the reader 226 at least 1 inch within the tube 224 may prevent the reader 226 from reading unintended identification tags 108 (e.g., cross-contamination of container specific information signals), for example. In some examples, the tube 224 may reduce occurrences of the cross-contamination of container specific information signals (e.g., RFIDs). A range of the reader 226 may range from 0 feet to 100 feet, for example. The material handling device 200 may also include sensors 227 that may utilize radar and/or lidar to detect obstructions (and distances and times to the obstructions) in addition to the cameras 222a-f to assist with navigation of the material handling device 200.

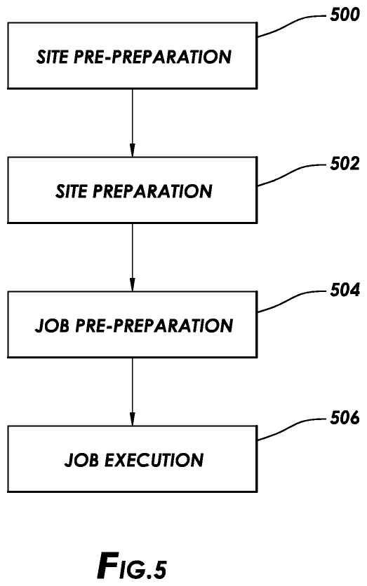

In some examples, as previously mentioned, the material handling device 200 may be in communication with a global positioning system (“GPS”). The material handling device 200 may include a communication device 230 including at least one transmitter 231a and/or at least one receiver 233a. In some examples, the communication device 230 may be configured to emit and/or receive wireless signals for various wireless protocols (e.g., radio, Bluetooth, Wifi, cellular, and/or GPS). In some examples, the communication device 230 may include a GPS transmitter 231b and/or a GPS receiver 233b. That is, the communication device 230 may be in communication with GPS satellites (not shown) continuously and may be monitored by the GPS. Location information of the material handling device 200 may be determined with the communication device 230 and the GPS. The location information may include coordinates, speed, direction, and spatial orientation relative to objects and/or people, for example. In other examples, the material handling device 200 may be monitored with a local positioning system (“LPS”). Similar to the GPS, the LPS may also be utilized to determine the location information of the material handling device 200. LPS may utilize signal beacons (e.g., signal beacons 436 shown on FIG. 4) to determine the location information. In certain examples, triangulation (e.g., radio frequency triangulation) may be utilized to estimate the location information of the material handling device 200.

The material handling device 200 may also include an onboard computer 232 that is in communication with a system controller (e.g., the system controller 415 shown on FIG. 4). The onboard computer 232 may operate the material handling device 220 based on instructions received from the system controller 415, for example. For example, the system controller 415 may communicate origin and delivery points to the material handling device 200 and may instruct the material handling device 200 to pick-up and deliver a container. The material handling device 200 may utilize sensory components such as the cameras 222a-f and sensors 227, and a positioning or navigation system such as an LPS or GPS to locate the containers, move the containers from an origin, and deliver the containers to a delivery point(s). The onboard computer 232 may also receive wheel load information from the wheel load sensors 206 and may calculate turning radiuses based on a weight of the load 208 sensed, as well as radial moments based on the weight of the load 208 to prevent tipping of the material handling device 200. The onboard computer 232 may also determine massive load reductions or weight shifting and may cause the material handling device 200 to slow down or straighten from a turn based on sensed load information. Significant load reduction during braking, acceleration, or turning may indicate a potential instability situation, thus the onboard computer 232 may cease a loading or unloading operation. In some examples, the onboard computer 232 may receive load position information from the load position sensors 218, and may cause fork 210 to move up and/or down (e.g., height adjustment) along the rail 212 based on this information, to allow loading or unloading of a container at a specific space (e.g., a shelf) at a designated area. The onboard computer 232 may cause the material handling device 200 to follow a prescribed navigation path (e.g. a navigation path from an origin to a destination or delivery point) and operate the fork 210 based on a known target (e.g., the identification tags 108, the load 208, origin of the load 208, and/or a delivery point for the load 208).

The onboard computer 232 may determine a route (e.g., navigation paths 412a and 412b shown on FIG. 4) based on origins and delivery points, proximity to objects (e.g., other material handling devices in the vicinity) and people, locations of the containers, and loads on the wheels, for example. In some examples, the onboard computer 232 may also store the scanned ID data as well as the origins and delivery points, proximity to objects (e.g., other material handling devices in the vicinity) and people, locations of the containers, and loads on the wheels. The onboard computer 232 may also store pre-planned navigation paths (or have access to pre-planned navigation paths via the system controller 415 shown on FIG. 4, for example) and may be configured to modify the pre-planned navigation path or a current navigation path(s) upon receiving instructions from a system controller (e.g., a system controller 415, shown on FIG. 4), for example.

Additionally, the onboard computer 232 may cause the material handling device 200 to deviate from a current navigation path, as needed (e.g., to avoid a collision or a change of a delivery origin or delivery point) and may notify the system controller 415 of this deviation. The material handling device 200 may return to its original navigation path after deviating, in some examples. The onboard computer 232 may also store or have access to a pre-planned navigation path(s) of other material handling devices to prevent collisions with the material handling device 200. The material handling device 200 may operate autonomously by utilizing its sensory components such as the cameras 222a-f, the load position sensors 218, wheel load sensors 206, and the sensors 227, to transport containers and/or avoid collisions, for example. In some examples, autonomy of the material handling device 200 may be assisted with the GPS or LPS.

FIG. 3 illustrates a side perspective view of an example of an autonomous material handling device 300 that may be similar to the material handling device 200 in accordance with examples of the present disclosure. A rail 302 (e.g., similar to the rail 212 shown o FIG. 2) is slanted backward toward a cab 304 of the material handling device 300 as the material handling device 200 raises a load 306 (e.g., similar to the load 208 shown on FIG. 2). The rail 302 may be slanted backward to move a center of gravity of the load 306 to above the wheels 202 (front wheels) which may reduce a likelihood of the material handling device 300 tipping due to the load 306.

FIG. 4 illustrates an example site 400 with material handling devices 401a and 401b operating simultaneously in accordance with examples of the present disclosure. The material handling devices 401a and 401b may be similar to the material handling device 200 shown on FIG. 2, for example. A size of the site 400 may range from 500 square feet to 1 acre, for example. In other examples, the size of the site 400 may be less than 500 square feet; or greater than 1 acre such as from 1 acre to 10 acres. The site 400 may include more than two material handling devices (e.g., 3-100 material handling devices). The number of material handling devices may be modified at any time and there may not be any lower or upper limit as to the number of material handling devices on the site 400. That is, additional material handling devices may be activated by a system controller (e.g., the system controller 415) for operation on the site 400 at any time. Similarly, any number of material handling devices can be deactivated by the system controller 415 at any time, for example.

The system controller 415 of the site 400 may be in continuous communication with the onboard computer (e.g., the onboard computer 232 shown on FIG. 2) of each of the material handling devices 401a and 401b via a transmitter and receiver (e.g., the communication device 230 shown on FIG. 2). The system controller 415 may be positioned on the site 400 or may be remote and may include a transmitter 419a and a receiver 421b for communication with the onboard computer 232 via the communication device 230 (shown on FIG. 2) of the material handling devices 401a and 401b, for example. In some examples, the system controller 415 may be configured to emit and/or receive wireless signals for various wireless protocols (e.g., radio, Bluetooth, Wifi, cellular, and/or GPS) for communication with the material handling devices 401a and 401b. In certain examples, the system controller 415 may include a GPS transmitter 419b and/or a GPS receiver 421b. That is, the system controller 415 may be in communication with GPS satellites (not shown) continuously and may be monitored by the GPS. Location information of the material handling device 200 may be determined with the system controller 415 and the GPS.

In some examples, the site 400 may be an industrial site situated outdoors such as a loading yard. In other examples, the site 400 may be indoors such as inside a warehouse. The site 400 may comprise containers 402a-402e. The containers 402a-402c may be similar to the container 100, as shown on FIG. 1 for example. The containers 402a-402c may contain the granular materials such as sand and/or proppant, for example. The containers 402d may be similar to the container 104 shown on FIG. 1 and may contain the chemical additives, for example. The containers 402e may be similar to the container 102 shown on FIG. 1 and may contain the fluids such as gas and/or liquids, for example. The containers 402a-402e (e.g., containers full of material) may be stacked in designated areas: area 404 includes twelve vertical stacks of containers 402a, for example; area 406 includes four vertical stacks of the containers 402b, for example; area 407 includes four vertical stacks of the containers 402c, for example; area 408 includes three vertical stacks of the containers 402d, for example; and area 410 includes two vertical stacks the containers 402e, for example. Each of the stacks may include 1 through 50 containers, for example. It should be noted that there may be no upper or lower limit as to the number of designated areas, the number of stacks, or the number of containers per stack.

As illustrated, the material handling devices 401a and 401b may travel along navigation paths 412a and 412b, respectively. In certain examples, the navigation paths 412a and 412b may be prescribed by onboard computers of each of the material handling devices 401a and 401b (e.g., an onboard computer 232 shown on FIG. 2). In other examples, the material handling devices 401a and 401b may operate without prescribed navigation paths and may transport any of the containers 402a-402e to various delivery points.

As noted previously, in some examples, the onboard computers 232 of the material handling devices 401a and 401b may determine, in real-time, a route or path to avoid collisions and deliver any of the containers 402a-402e as fast as possible without tipping over. The onboard computers 232 may determine a route based on origins and delivery points, proximity to objects (e.g., other material handling devices in the vicinity) and people, locations of the containers, and loads on the wheels, for example.

The material handling device 401a may transport, via the navigation path 412a, a container 402a from the area 404, to a structure 414a (e.g., framework) positioned directly above a blender 416a. The blender 416a may blend various materials together. There may be additional blenders on the site 400, such as blenders 416b and 416c which may be similar to the blender 416a, for example. Each of the blenders 416a-416c may have any combination of the containers 402a-402e disposed above the blenders 416a-416c in the support structures 414a-414c, for example. The site 400 may also include pumping equipment 418 and/or a manifold trailer 420.

The support structures 414a-414c may be equipped with indicators 417 (e.g., lights that may be detected by the cameras 222a-f shown on FIG. 2) to indicate where each container should be exactly placed by the material handling device 401a. The indicators 417 may be positioned on the support structures 414a-414c such that the containers are placed between the indicators 417, for example.

In some examples utilizing the GPS, the onboard computers 232 (shown on FIG. 2) of the material handling devices 401a and 401b are in continuous communication with the GPS (e.g., GPS satellites) such that the material handling devices 401a and 401b are continuously aware of their positions. The onboard computers 232 of each of the material handling devices 401a and 401b may continuously receive location information from the GPS satellites. In certain examples, the material handling devices 401a and 401b may transmit the location information to the system controller 415. In some examples, the system controller 415 continuously receives the location information for each of the material handling devices 401a and 401b. Alternatively, the location information may be transmitted directly to the system controller 415 from the GPS satellites.

Additionally, the system controller 415 may include (e.g., store or have access to) a log of all material handling device operations including delivery points, origin points, durations of deliveries, an inventory of containers that are scheduled for transport as well as containers that have been transported, as well as record times of initiation of an operation to termination of the operation. The material handling device 401a may travel along the navigation path 412a until loading of the container 402a onto the structure 414a is complete. For example, the material handling device 401a may scan an identification tag of a container 402a (e.g., the identification tag 108 shown on FIG. 1) with a reader (e.g., the reader 226 to read RFID shown on FIG. 2) or a camera (e.g., cameras 222a-f to read a barcode shown on FIG. 2). Upon completion of the scan, the material handling device 401a may store the information read (e.g., the ID data) and may transmit the ID data to the system controller 415. The system controller 415 may confirm or determine that a delivery point for the container 402a is the structure 414a and therefore may instruct the material handling device 401a to deliver the container 402a to the structure 414a. If the delivery point changes, the system controller 415 may re-route the material handling device 401a to the correct delivery point, for example.

The material handling device 401a may utilize radar and/or lidar (e.g., the sensors 227 shown on FIG. 2), load position sensors (e.g., the load position sensors 218 shown on FIG. 2), and/or cameras (e.g., the cameras 222a-f shown on FIG. 2) to place the container 402a on or in the structure 414a. After delivery of the container 402a on the structure 414a, the material handling device 401a may notify the system controller 415 that delivery is complete. Upon being notified of delivery of the container 402a at the structure 414 (e.g., a delivery point), the system controller 415 may direct the material handling device 401a to cease operation and may also direct the material handling device 401a to begin another task or move to an area of the site 400 that does not interfere with other material handling devices on the site 400 to avoid collisions.

The site 400 may also include a zone 422 (e.g., a designated area) adjacent to a road 424. The zone 422 may be a loading or unloading zone. For example, a truck 426a with a stack of full containers 428a and 428b may deliver the containers 428a and 428b to the zone 422 thereby allowing the material handling device 401b to remove the container 428a from the truck 426a and deliver the container 428a to the area 407 in a stacked position. After delivery of the container 428a to the area 407, the material handling device 401b may return to the truck 426a to pick up the container 428b for delivery to the area 407. The containers 428a and 428b may be stacked together or separately. The containers 428a and 428b may be added to an existing stack or each may be the first container in a new stack. The material handling device 401b may travel along the navigation path 412b until unloading of the truck 426a is complete, or until termination of the unloading operation (e.g., instructed by the system controller 415).

In some examples, the material handling device 401b may scan an identification tag (e.g., the identification tag 108 shown on FIG. 1) of the container 428a and transmit the ID data to the system controller 415. The system controller 415 may confirm or determine that the delivery point for the container 428a is the area 407 and instruct the material handling device 401b to deliver the container 428a from a truck 426a to the area 407. Similarly, for the container 428b, the material handling device 401b may scan an identification tag (e.g. the identification tag 108 shown on FIG. 1) of the container 428b. Then, the system controller 415 may confirm or determine that the delivery point for the container 428b is the area 407 and direct the material handling device 401b to deliver the container 428b from the truck 426a to the area 407. If the delivery points for the container 428a or 428b change, the system controller 415 may re-route the material handling device 401b to the correct delivery point(s), for example.

After placing (e.g., stacking) the containers 428a and 428b in the area 407, the material handling device 401b may notify the system controller 415 that the delivery is complete. Upon being notified of delivery of the containers 428a and 428b at the intended delivery point(s), the system controller 415 may direct the material handling device 401b to perform another task such as to load empty containers 432a and 432b onto a truck 426b, for example. In some examples, the empty containers 432a and 432b may each include a transponder 433 that emits a distress signal indicating that these containers are empty. In certain examples, the system controller 415 may be in communication with the transponder 433 and may instruct the transponder 433 to emit the distress signal upon learning that the containers 432a and/or 432b are empty. The distress signal may be received directly by the material handling device 401b via the communication device 230 shown on FIG. 2, for example. Upon being notified of the empty containers 432a and 432b via the distress signals, the material handling device 401b may navigate to the empty containers 432a and 432b to load them onto the truck 426b. The transponder 433 may stop emitting the distress signals when the material handling device 401b transmits a signal (e.g., via the communication device 230 shown on FIG. 2) to the transponder 433 upon completion of the loading operation, for example. In other examples, the transponder 433 may be placed adjacent (e.g., on a neighboring structure) to the empty containers 432a and 432b, for example.

In an LPS, the material handling devices 401a and 401b may be in communication with signal beacons 434 that may extend along a perimeter of the site 400. The signal beacons 434 may be utilized to track the material handling devices 401a and 401b via triangulation. The signal beacons 434 may be positioned on towers 436 to increase range, for example. The towers 436 may have heights ranging from 20 feet to 200 feet for example. The site 400 may include four signal beacons 434, although more than four signal beacons 434 may be utilized per site (e.g., 10-100 beacons). However, at least three signal beacons 434 may need to be present on the site 400 to accurately (e.g., margin of error is 1 inch) track each of the material handling devices 401a and 401b via the triangulation.

The signal beacons 434 may be sensors including a transmitter 435a and a receiver 435b) may emit and/or receive ultrasonic, lidar, radar, radio, or infrared signals to obtain location information comprising coordinates, direction, and speed of the material handling devices 401a and 401b, for example. The signal beacons 434 may also include a transmitter 437a and a receiver 437b for communicating the location information to the material handling devices 401a and 401b. The signal beacons 434 may communicate with each of the material handling devices 401a and 401b, and the system controller 415 via wireless signals such as radio, cellular, Bluetooth, and/or Wifi signals, for example. The material handling devices 401a and 401b may avoid collisions and execute deliveries as fast as possible based on the location information acquired via the signal beacons 434, for example. In certain LPS examples, the material handling devices 401a and 401b may continuously communicate with the signal beacons 434. An example communication may be as follows: (1) The material handling devices 401a and 401b may each issue a “Locate or ping me” signal to at least three of the signal beacons 434 for triangulation; and (2) The signal beacons 434 may determine the location information for each of the material handling devices 401a and 401b and send the location information to each of the material handling devices 401a and 401b directly.

Alternatively, in some examples, the material handling devices 401a and 401b may relay the location information to the system controller 415. The onboard computers (e.g., the onboard computer 232 shown on FIG. 2) of each of the material handling devices 401a and 401b may compute their respective current locations based on a time difference between a time of the signal beacons 434 determining the location information, and a time of the material handling devices 401a and 401b receiving the location information from the beacons 434. The different times may be stored in the material handling devices (e.g., locally stored on the onboard computer 232 of each material handling device shown on FIG. 2) along with velocity profile(s), both of which allow calculations of the current locations of each of the material handling devices 401a and 401b, for example. That is, a distance lapsed by the material handling devices 401a and 401b may be added to the positions (e.g., coordinates) of the material handling devices 401a and 401b determined by the signal beacons 434 in order to determine current locations of the material handling devices 401a and 401b, for example.

FIG. 5 illustrates a flow chart of site preparation in accordance with examples of the present disclosure. At step 500 (Site Pre-preparation), a floor of a site (e.g. the site 400 shown on FIG. 4) may be constructed from cement, gravel, and/or dirt, and signal beacons (e.g., the signal beacons 434 also shown on FIG. 4) may be positioned on the site. In certain examples, the signal beacons may be positioned on towers such as the towers 436 shown on FIG. 4, for example. Also, the material handling devices (e.g., the material handling devices 401a and 401b shown on FIG. 4) may be delivered to the site.

At step 502 (Site Preparation), delivery trucks (e.g., the truck 426a shown on FIG. 4) may deliver containers (e.g., the containers 428a and 428b shown on FIG. 4) to the site. The material handling devices may sense the containers with cameras (e.g., the cameras 222a-f shown on FIG. 2) and /or a reader (the reader 226 shown on FIG. 2) or the material handling devices are informed by a system controller (e.g., the system controller 415 shown on FIG. 4) to transport the containers. Next, the material handling devices may approach the containers and scan identification tags (e.g., the identification tags 108 shown on FIG. 1) of the containers and store the ID data with onboard computers of the material handling devices (e.g., the onboard computer 232 shown on FIG. 2). The material handling devices may relay the ID data of each of the containers to the system controller for inventory. For example, the system controller may monitor and store a record of containers that have been delivered, and containers that are scheduled for delivery. Then, the material handling devices may stack the containers in designated areas (e.g., area 407 shown on FIG. 4) and store the delivery point (i.e., the delivery location) with the onboard computers which may relay the delivery point to the system controller.

At step 504 (Job Pre-Preparation), the system controller may determine the number of containers offloaded from the truck and may determine a number of material handling devices needed on the site. The system controller may download a material schedule that includes origins, delivery points, and contents of the containers. The system controller may prescribe navigation paths for each material handling device (e.g., the navigation paths 412a and 412b shown on FIG. 4) to reduce collisions. Any other equipment such as pumping equipment or a manifold trailer (e.g., the pumping equipment 418 and/or a manifold trailer 420 shown on FIG. 4) may be placed on the site. Any sand, water, and/or chemical additives containers (e.g., the containers 100 and/or 104 shown on FIG. 1) may be delivered first.

At step 506 (Job Execution), the material handling devices may be alert for distress signals (e.g., transponders 433 shown on FIG. 4) from empty containers (e.g., the containers 432a and 43b shown on FIG. 4). The distress signal may be a wireless signal including a radio, Bluetooth, cellular, and/or Wifi signal, for example. The empty containers may be delivered to a designated area for empty containers (e.g., the truck 426b shown on FIG. 4). The material handling devices may deliver full containers (e.g., the containers 402a shown on FIG. 4) from a stack to a production line (e.g., the blender 416 shown on FIG. 4). The material handling devices are continuously aware of their location and local environment including obstructions and/or potential collision points due to various sensing components such as, for example, the cameras 222a-f and the sensors 227 (radar and/or lidar) as shown on FIG. 2, for example. The material handling devices may continuously ping the signal beacons (e.g., the signal beacons 434 shown on FIG. 4) to initiate triangulation and compute actual position based on material handling device speed.

Certain examples of the present disclosure may utilize the onboard computer 232 or the system controller 415, each including any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. The onboard computer 232 and the system controller 415 may be any processor-driven device, such as, but not limited to, a personal computer, laptop computer, smartphone, tablet, handheld computer, dedicated processing device, and/or an array of computing devices. In addition to having a processor, the onboard computer 232 and the system controller 415 may each include a server, a memory, input/output (“I/O”) interface(s), and a network interface. The memory may be any computer-readable medium, coupled to the processor, such as RAM, ROM, and/or a removable storage device for storing data and a database management system (“DBMS”) to facilitate management of data stored in memory and/or stored in separate databases. The onboard computer 232 and the system controller 415 may also include display devices such as a monitor featuring an operating system, media browser, and the ability to run one or more software applications. Additionally, the onboard computer 232 and the system controller 415 may include non-transitory computer-readable media. Non-transitory computer-readable media may include any instrumentality or aggregation of instrumentalities that may retain data and/or instructions for a period of time.

Accordingly, the systems, methods, and apparatuses of the present disclosure may utilize at least one self-driven motorized material handling device that may safely and autonomously navigate across a site to deliver containers from an origin to a delivery point. The systems, methods, and apparatuses may include any of the various features disclosed herein, including one or more of the following statements.

Statement 1. A system for on-site logistics comprising: a plurality of containers that are organized by type, each container comprising an identification tag; at least three signal beacons configured to at least emit or receive signals; and at least one autonomous material handling device configured to locate the containers, move the containers, and store delivery points of the containers, wherein the at least one autonomous material handling device is in communication with the at least three signal beacons.

Statement 2. The system of the statement 1, further comprising a system controller in communication with the at least one autonomous material handling device, the system controller configured to instruct the at least one autonomous material handling device to move the containers.

Statement 3. The system of the statement 2, wherein the system controller is configured to prescribe a navigation path for the at least one autonomous material handling device.

Statement 4. The system of any of the preceding statements, further comprising a second autonomous material handling device configured to locate and move the containers and store delivery points of the containers, wherein the second autonomous material handling device is in communication with the at least three signal beacons, wherein each of the material handling devices is configured to avoid collisions.

Statement 5. The system of any of the preceding statements, wherein the at least one autonomous material handling device comprises a camera configured to read the identification tag, the identification tag comprising a barcode.

Statement 6. The system of any of the preceding statements, wherein the at least one autonomous material handling device comprises a radio frequency identification (RFID) tag reader, the identification tag comprising RFID.

Statement 7. The system of any of the preceding statements, wherein the at least one autonomous material handling device comprises load sensors positioned adjacent to wheels of the at least one autonomous material handling device, wherein load sensor data is used to calibrate content of each container.

Statement 8. A system for on-site logistics comprising: a plurality of containers that are organized by type, each container comprising an identification tag; and at least one autonomous material handling device configured to locate the containers, move the containers, and store delivery points of the containers, wherein the at least one autonomous material handling device comprises a global positioning system (GPS) communication device.

Statement 9. The system of the statement 8, further comprising a system controller in communication with the at least one autonomous material handling device, the system controller configured to instruct the at least one autonomous material handling device to move the containers.

Statement 10. The system of the statement 9, wherein the system controller is configured to prescribe a navigation path for the at least one autonomous material handling device.

Statement 11. The system of any of the statements 8-10, further comprising a second autonomous material handling device configured to locate the containers, move the containers, and store delivery points of the containers, wherein the second autonomous material handling device comprises a GPS communication device, wherein each of the material handling devices is configured to avoid collisions.

Statement 12. The system of any of the statements 8-11, wherein each container comprises at least proppant or sand.

Statement 13. The system of any of the statements 8-12, wherein each container comprises water, brine, a liquefied natural gas, or a liquefied petroleum gas.

Statement 14. The system of any of the statements 8-13, wherein each container comprises propane, carbon dioxide, nitrogen, a cryogenic fluid, or chemical additives, wherein material handling device positioning includes different algorithms due to sloshing of fluids in the containers.

Statement 15. A method for on-site logistics comprising: scanning identification tags of a plurality of containers that are organized by type, with at least one autonomous material handling device; transmitting information from the identification tags, with the at least one autonomous material handling device, to a system controller that is separate from the at least one autonomous material handling device; transmitting a location of the at least one autonomous material handling device from the at least one autonomous material handling device to the system controller; delivering the containers; storing delivery points with the at least one autonomous material handling device; and transmitting delivery points of the containers from the at least one autonomous material handling device to the system controller.

Statement 16. The method of the statement 15, further comprising: scanning identification tags of a second plurality of containers with a second autonomous material handling device; transmitting information from the identification tags of the second plurality of containers, with the second autonomous material handling device, to the system controller; transmitting a location of the second autonomous material handling device from the second autonomous material handling device to the system controller; delivering the second plurality of containers; storing delivery points with the second autonomous material handling device; and transmitting delivery points of the second plurality of containers from the second autonomous material handling device to the system controller.

Statement 17. The method of any of the statements 15-16, further comprising instructing the material handling devices with the system controller.

Statement 18. The method of any of the statements 15-17, further comprising receiving distress signals at each of the material handling devices from empty containers.

Statement 19. The method of any of the statements 15-18, further comprising receiving global positioning system (GPS) signals at each of the material handling devices, each material handling device comprising a GPS communication device.

Statement 20. The method of any of the statements 15-19, further comprising receiving signals at each of the material handling devices, wherein the signals are emitted from at least three signal beacons, the signals comprising ultrasonic, lidar, radar, radio, or infrared signals.

It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the elements that it introduces. The term “coupled” means directly or indirectly connected.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A system for on-site logistics comprising:
a plurality of containers that are organized by type, each container comprising an identification tag;
at least three signal beacons configured to at least emit or receive signals; and
at least one autonomous material handling device configured to locate the containers, move the containers, and store delivery points of the containers, wherein the at least one autonomous material handling device is in communication with the at least three signal beacons.

2. The system of claim 1, further comprising a system controller in communication with the at least one autonomous material handling device, the system controller configured to instruct the at least one autonomous material handling device to move the containers.

3. The system of claim 2, wherein the system controller is configured to prescribe a navigation path for the at least one autonomous material handling device.

4. The system of claim 1, further comprising a second autonomous material handling device configured to locate and move the containers and store delivery points of the containers, wherein the second autonomous material handling device is in communication with the at least three signal beacons, wherein each of the material handling devices is configured to avoid collisions.

5. The system of claim 1, wherein the at least one autonomous material handling device comprises a camera configured to read the identification tag, the identification tag comprising a barcode.

6. The system of claim 1, wherein the at least one autonomous material handling device comprises a radio frequency identification (RFID) tag reader, the identification tag comprising RFID.

7. The system of claim 1, wherein the at least one autonomous material handling device comprises load sensors positioned adjacent to wheels of the at least one autonomous material handling device.

8. A system for on-site logistics comprising:
a plurality of containers that are organized by type, each container comprising an identification tag; and
at least one autonomous material handling device configured to locate the containers, move the containers, and store delivery points of the containers, wherein the at least one autonomous material handling device comprises a global positioning system (GPS) communication device.

9. The system of claim 8, further comprising a system controller in communication with the at least one autonomous material handling device, the system controller configured to instruct the at least one autonomous material handling device to move the containers.

10. The system of claim 9, wherein the system controller is configured to prescribe a navigation path for the at least one autonomous material handling device.

11. The system of claim 8, further comprising a second autonomous material handling device configured to locate the containers, move the containers, and store delivery points of the containers, wherein the second autonomous material handling device comprises a GPS communication device, wherein each of the material handling devices is configured to avoid collisions.

12. The system of claim 8, wherein each container comprises at least proppant or sand.

13. The system of claim 8, wherein each container comprises water, brine, a liquefied natural gas, or a liquefied petroleum gas.

14. The system of claim 8, wherein each container comprises propane, carbon dioxide, nitrogen, a cryogenic fluid, or chemical additives.

15. A method for on-site logistics comprising:
scanning identification tags of a plurality of containers that are organized by type, with at least one autonomous material handling device;
transmitting information from the identification tags, with the at least one autonomous material handling device, to a system controller that is separate from the at least one autonomous material handling device;
transmitting a location of the at least one autonomous material handling device from the at least one autonomous material handling device to the system controller;
delivering the containers;
storing delivery points with the at least one autonomous material handling device; and
transmitting delivery points of the containers from the at least one autonomous material handling device to the system controller.

16. The method of claim 15, further comprising:
scanning identification tags of a second plurality of containers with a second autonomous material handling device;
transmitting information from the identification tags of the second plurality of containers, with the second autonomous material handling device, to the system controller;
transmitting a location of the second autonomous material handling device from the second autonomous material handling device to the system controller;
delivering the second plurality of containers;
storing delivery points with the second autonomous material handling device; and
transmitting delivery points of the second plurality of containers from the second autonomous material handling device to the system controller.

17. The method of claim 16, further comprising instructing the material handling devices with the system controller.

18. The method of claim 16, further comprising receiving distress signals at each of the material handling devices from empty containers.

19. The method of claim 16, further comprising receiving global positioning system (GPS) signals at each of the material handling devices, each material handling device comprising a GPS communication device.

20. The method of claim 16, further comprising receiving signals at each of the material handling devices, wherein the signals are emitted from at least three signal beacons, the signals comprising ultrasonic, lidar, radar, radio, or infrared signals.
